(19) United States
(12) Patent Application Publication
(10) Pub. No.: US 2004/0006844 A1
(43) Pub. Date: Jan. 15, 2004

(54) Suspension device

(76) Inventor: Raimund Modlhammer, Berlin (DE)

Correspondence Address: BURNS, DOANE, SWECKER & MATHIS, L.L.P., P.O. Box 1404, Alexandria, VA, 22313-1404, US

(21) Appl. No.: 10/606,769

(22) Filed: Jun. 27, 2003

Related U.S. Application Data
(63) Continuation-in-part of application No. PCT/DE02/01659, filed on May 8, 2002.

(30) Foreign Application Priority Data
May 14, 2001 (DE) 201 08 132.6

(51) Int. Cl. B60B 33/00

(52) U.S. Cl. 16/18 R

(57) ABSTRACT

A suspension device (1) for a wheel (7) carried by a wheel mount (3) includes hub body (9) which is arranged in the wheel (7) and, together with the wheel (7), is mounted so as to be pivotable to a limited extent about a supporting axle (17) provided on the wheel mount (3), wherein the supporting axle (17) is spaced from the carrying axis of the wheel (7) and wherein a spring member (19) is provided which co-operates with the hub body (9) so as to cushion the pivoting movement of the hub body (9). The wheel mount (3) carries at least one abutment member (18) which is spaced from the supporting axle (17) and on which the at least one hub body (9) is supported or is supportable by means of the at least one spring member (19).

The present application is a continuation-in-part of PCT/DE02/01659, filed on May 8, 2002, and which claims the priority of DE 201 08 132.6, filed on May 14, 2001. The contents of both applications are incorporated herein by reference.

### BACKGROUND OF THE INVENTION

1. Field of the Invention

The invention relates to a suspension for a wheel.

2. Description of Related Art

Suspension devices for rollers and wheels are known from patent specifications U.S. Pat. No. 2,443,900, U.S. Pat. No. 2,721,766 and DE-C 567 164. These devices have a supporting axle which is eccentrically arranged in relation to the wheel axis and about which the hub of the wheel can pivot. A resilient member supports the hub relative to a fixed part. If the wheel strikes an obstacle, the hub executes a pivoting movement, as a result of which the wheel yields to the obstacle.

A disadvantage of these known suspension devices lies in the difficulty of producing a space-saving and cost-effective design which makes it possible to achieve suspension behaviour corresponding to a quite particular, predetermined spring characteristic. Usually, the predetermined spring characteristic requires spring dimensioning which cannot be accommodated in the structural space provided. Manufacture and assembly are also costly because the design consists of many parts. The suspension device known from patent specification U.S. Pat. No. 5,493,755 uses an elastomer spring member which is subjected to torsional stress. This design does not allow a large pivoting angle and also loads the material in a way which does not optimally utilise the volume of the spring member. This results in overloading of the outer zone, while inner regions have not yet been optimally loaded.

### OBJECTS AND SUMMARY

An object of the invention is the further development of a suspension device of the present type so that the necessary manufacturing costs are reduced in comparison with suspension devices known hitherto, so that a modular construction is possible and so that the characteristic of the suspension is variable by simple means.

The invention has the advantage that the suspension device can be manufactured from few components and without taking up a lot of structural space. The spring member is only subjected to compressive or axial loads. A simple elongate component with, e.g., a round cross-section can be used as an abutment member. Only two openings for receiving the abutment member are needed in the wheel mount. In comparison with a conventional roller without any suspension, the number of components is increased by only three parts, namely the hub body, the spring member and the abutment member. Furthermore, when the roller is assembled, owing to the modular construction of the suspension device, the spring member can be selected in accordance with the expected requirements (spring characteristic) and also be replaced subsequently with little expenditure. The material of the spring member is optimally utilised and, together with a long service life in the limited structural space of the hub body, suspension with a large work capacity can be achieved.

A suspension device for a wheel carried by a wheel mount, the suspension device comprising at least one hub body which is arranged in the wheel and, together with the wheel, the at least one hub body is mounted so as to be pivotable about a supporting axle provided on the wheel mount, wherein the supporting axle is spaced from the carrying axis of the wheel and wherein at least one spring member is provided which co-operates with the at least one hub body so as to cushion the pivoting movement of the hub body, characterised in that the wheel mount carries at least one abutment member which is spaced from the supporting axle and on which the at least one hub body is supported or is supportable by means of the at least one spring member.

### BRIEF DESCRIPTION OF THE DRAWINGS

FIG. 1 shows an exploded view of an embodiment with two bearings;

FIG. 2 shows a sectional view of FIG. 1 in the unloaded state;

FIG. 3 shows a sectional view of FIG. 2 in the loaded state;

FIGS. 4 and 5 each show an exploded view of an embodiment for a single bearing; and

FIG. 6 shows a side view of FIG. 5.

### DETAILED DESCRIPTION OF THE PREFERRED EMBODIMENTS

The suspension devices 1 described hereinbelow can be put into practical use in wheels 7 carried by wheel mounts of any design.

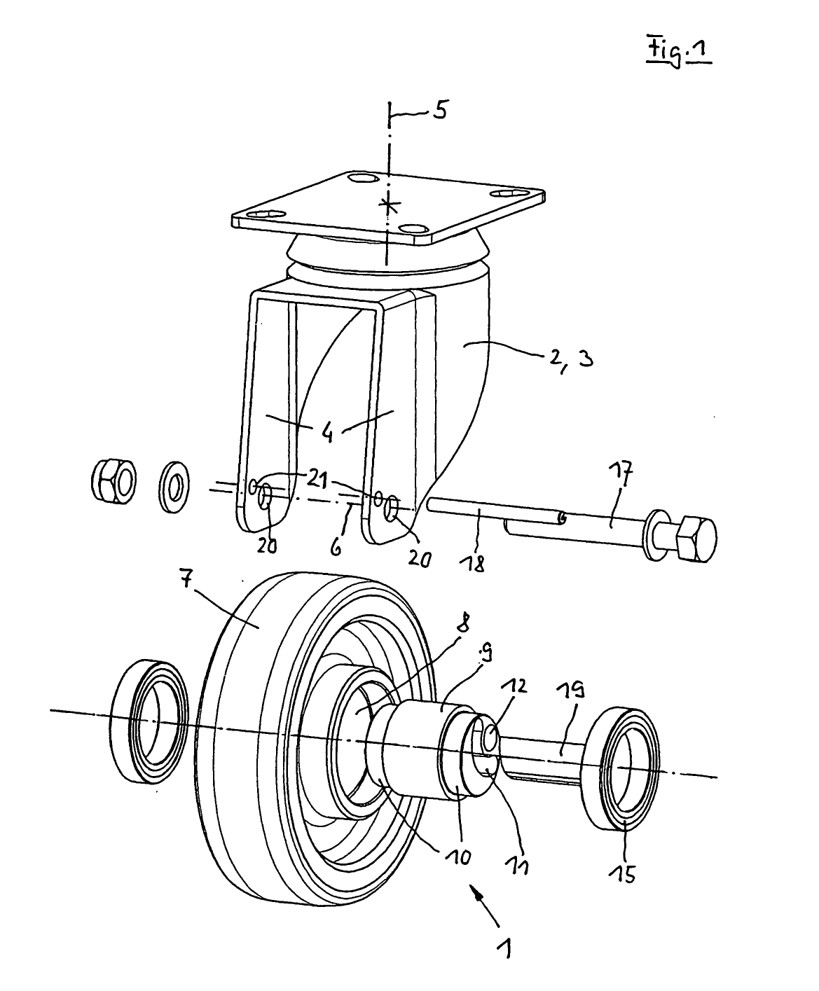

The embodiment according to FIG. 1 comprises a suspension device 1 provided, e.g., on a roller 2 formed as a caster. The roller 2, which is swivellable about a vertical axis 5, has a wheel mount 3 for carrying a wheel 7 rotatably mounted on a horizontal axis 6 (carrying axis) and for carrying the suspension device 1. The suspension device 1 comprises a cylindrical hub body 9, a spring member 19 and an abutment member 18.

The wheel 7 is provided with a concentric cylindrical opening 8 arranged in a center thereof for receiving the hub body 9, the outer diameter of the hub body 9 being slightly smaller than the inner diameter of the cylindrical opening 8.

The hub body 9 has two spaced cylindrical bearing seats 10 for receiving two bearings 15, preferably formed as roller bearings, which are inserted into the cylindrical opening 8 with an accurate fit. The hub body 9 has a horizontally extending space 11 in the form of a curved slot, through which the abutment member 18, formed as a rod in the example, is guided.

The spring member 19, which is formed, e.g., as an elastomer and co-operates with the abutment member 18, is also housed in the space 11. At a distance from the space 11, the hub body 9 has a horizontally extending through bore 12 provided for receiving a supporting axle 17, by means of which the wheel 7 is fixable to the fork arms 4 of the wheel mount 3. The through bore 12 is offset from the axis of the wheel. For this purpose, each fork arm 4 has a horizontally extending first opening 20 to enable the supporting axle 17 to be secured to the fork arms 4. A second horizontally arranged opening 21 is provided in each fork arm 4 at a distance from the first openings 20 and is provided for receiving and securing the abutment member 18. Fixing means of the conventional type are used to secure the supporting axle 17 and the abutment member 18, arranged parallel to the supporting axle 17, to the fork arms 4. The hub body 9 is arranged between the fork arms 4 with slight lateral clearance.

When the suspension device 1 is in the assembled state, the spring member 19 either already rests with slight pressure against the abutment member 18 or, for reasons of easier assembly, there is a small amount of clearance between the spring member 19 and the abutment member 18. When the wheel 7 is under load, the hub body 9, and with it the wheel 7, executes a pivoting movement so that the spring member 19, which is positively accommodated in the space 11, is pushed against the fixedly arranged abutment member 18. During this spring deflection process, the spring member 19 is deformed and absorbs energy. If the wheel 7 is relieved of load, the spring member 19 releases energy so that the wheel moves back into the starting position as in a rebound process. The spring member 19 can also be formed so that it is fixed both to the hub body 9 and to the wheel mount 3.

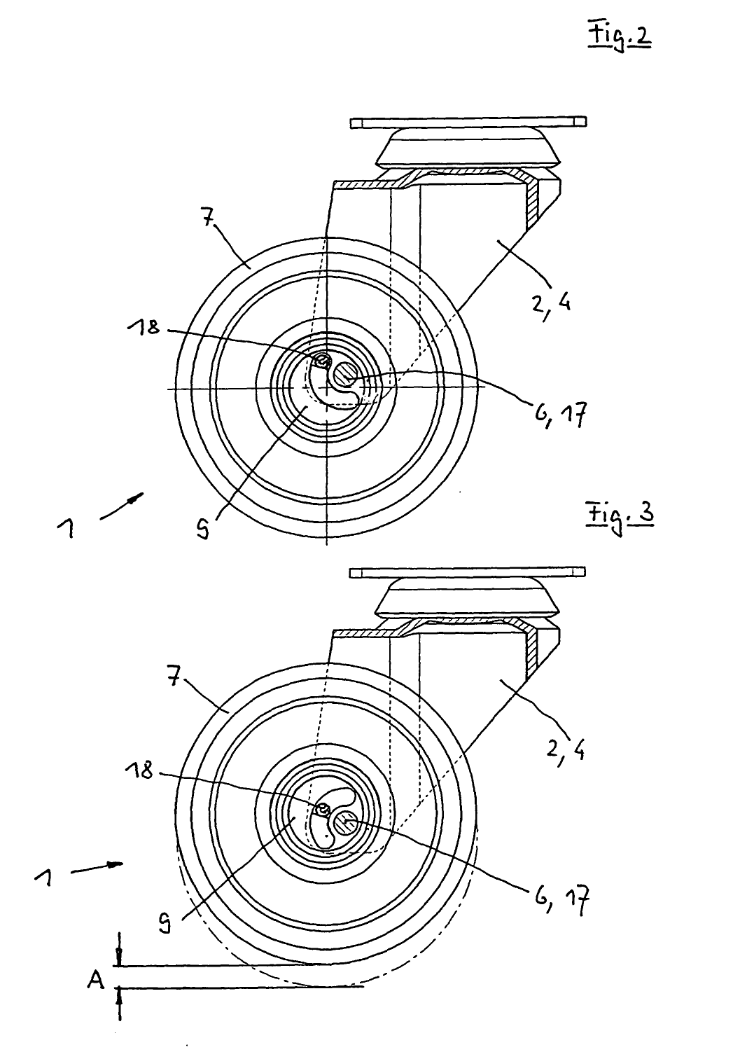

The effect of the suspension device 1 can be aptly described with reference to FIGS. 2 and 3. In each case, the roller 2 is shown in side view and partly in section. There is no load-bearing force acting on the roller 2 shown in FIG. 2, whereas the same roller 2 in FIG. 3 is shown subjected to a load-bearing force which induces the limited pivoting of the wheel 7 with the hub body 9 about the horizontal axis 6 of the supporting axle 17. The load-bearing force ultimately acting on the wheel 7 pushes the wheel 7, rotating clockwise in the drawing, upwards by the amount A, during which the abutment member 18 supported in the fork arms 4 is pressed against the spring member 19 and compresses it slightly. If the load-bearing force acting on the wheel 7 is low, the wheel 7 also only yields slightly and the amount A is smaller. If, however, the load-bearing force is high, this produces great deflection of the wheel 7 and correspondingly great compression of the spring member 19. The compression of the spring member 19 therefore results in cushioning of the wheel 7 in a shock-absorbing manner. Consequently, the suspension device 1 overall advantageously cushions the roller 2 in the event of shocks and loads occurring during use.

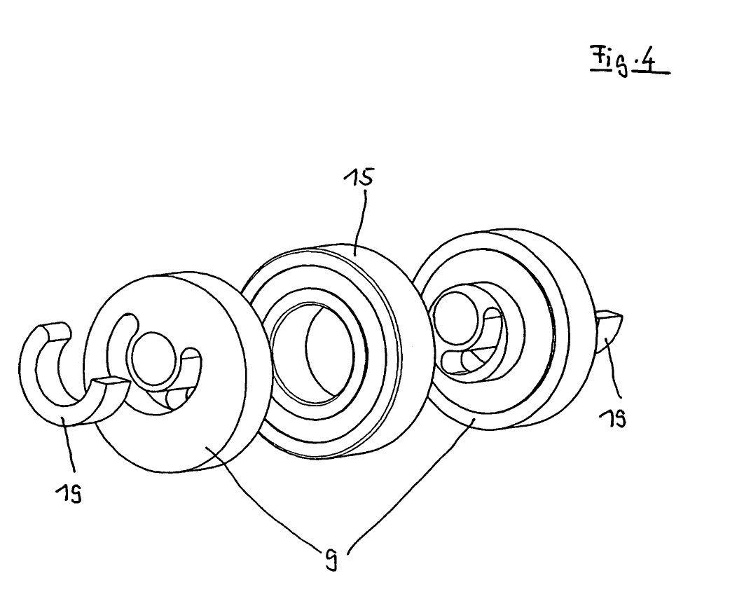

FIG. 4 shows an embodiment in which the hub body 9 is symmetrically formed in two parts, with the result that the wheel 7 can also be provided with only one bearing 15. In the example, a spring member 19 is provided for each hub body 9. A wheel 7 provided with these parts can be fitted into a wheel mount 3, for example as described in FIGS. 1 to 3.

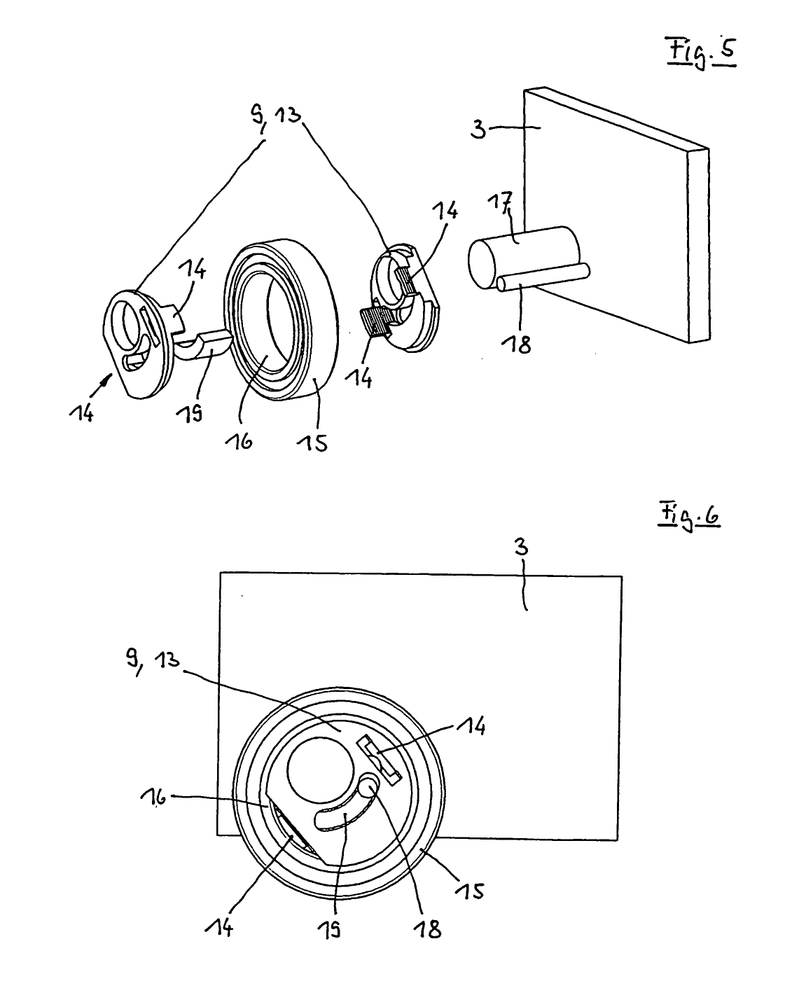

FIGS. 5 and 6 show an embodiment in which the hub body 9 is bipartite and the two halves 13 of the hub body 9 thus formed are identical and each have a tongue 14 with snap-in toothing on the inside and a tongue 14 with snap-in toothing on the outside, the tongues 14 being arranged so that, when the two halves 13 of the hub body 9 are inserted into the inner race 16 of the bearing 15, the tongue 14 with snap-in toothing on the inside of one half 13 meshes with the opposite tongue 14 with snap-in toothing on the outside of the other half 13. Finely stepped snap-in toothing makes it possible to use bearings 15 of different width with only one embodiment of a hub body 9. The spring member 19 is accommodated in a space-saving manner between the two halves 13 of the hub body 9. The described arrangement can be fitted into a wheel 7, and the wheel 7 thus formed can be fixed to a wheel mount 3 in the initially described manner.

Alternatively, a leg spring can be provided as a spring member 19. One end of the leg spring engages in the hub body 9 and its other end is looped around the supporting axle 17 so tightly that an adequate frictional connection is produced or is connected to a fixed part in another suitable manner.

As a further alternative, it is also possible to dispense with the wheel 7 and to transfer the function of the wheel 7 to at least one bearing 15. If just one bearing 15 were used as a wheel substitute, the hub body 9 would then have to be formed by two mutually engageable halves 13—see FIG. 5—and inserted into the inner race 16 of a bearing 15. This arrangement can also be fitted into a wheel mount 3.

Lastly, instead of only one abutment member 18, it is possible to provide a further such member, in which case each abutment member 18 would have to be fixedly arranged on a correspondingly formed wheel mount 3.

Although only preferred embodiments are specifically illustrated and described herein, it will be appreciated that many modifications and variations of the present invention are possible in light of the above teachings and within the purview of the appended claims without departing from the spirit and intended scope of the invention.

1. A suspension device for a wheel carried by a wheel mount, the suspension device comprising at least one hub body which is arranged in the wheel and, together with the wheel, the at least one hub body is mounted so as to be pivotable about a supporting axle provided on the wheel mount, wherein the supporting axle is spaced from the carrying axis of the wheel and wherein at least one spring member is provided which co-operates with the at least one hub body so as to cushion the pivoting movement of the hub body, the wheel mount carries at least one abutment member which is spaced from the supporting axle and on which the at least one hub body is supported or is supportable by means of the at least one spring member.

2. The suspension device according to claim 1, wherein the at least one spring member is intended to absorb compressive and axial loads.

3. The suspension device according to claim 1 wherein the hub body has a space for receiving the at least one spring member and through which the at least one abutment member is guided.

4. A suspension device according to claim 3, wherein the space is formed as a curved slot.

5. A suspension device according to claim 1, wherein the hub body is formed by two connectable halves.

6. The suspension device according to claim 5, wherein the halves of the hub body are connectable to one another in a snap-locking manner.

7. The suspension device according to claim 1, wherein the at least one spring member (19) is formed as an elastomer.

8. The suspension device according to of claim 1, wherein the at least one hub body is housed in a bearing.

9. The suspension device according to claim 8, wherein the bearing is formed as a wheel.

10. A suspension device for a wheel carried by a wheel mount, the suspension device comprising:
a hub body arranged in the wheel, the hub body including a bore extending therethrough, the bore being offset from a center of the hub body;
a supporting axle provided on the wheel mount and extending through the bore of the hub body so as to support the hub body and wheel, wherein the supporting axle is spaced from a carrying axis of the wheel;
an opening extending through the hub body in a direction parallel to a direction of the bore, said opening being spaced from the bore;
at least one spring arranged in the opening; and
an abutment member mounted on the wheel mount and extending through the opening so as to cooperate with the spring so as to cushion a pivoting movement of the hub body.
